(19) United States
(12) Patent Application Publication
(10) Pub. No.: US 2008/0029644 A1
(43) Pub. Date: Feb. 7, 2008

(54) Process for manufacturing composite material structures with collapsible tooling

(75) Inventors: Alberto Ramon Martinez Cerezo, Getafe (ES); Jose Cuenca Rincon, Getafe (ES); Jose Carrasco Carrascal, Getafe (ES)

Correspondence Address: LADAS & PARRY, 26 WEST 61ST STREET, NEW YORK, NY, 10023, US

(73) Assignee: AIRBUS ESPANA, S.L.

(21) Appl. No.: 11/651,403

(22) Filed: Jan. 9, 2007

(30) Foreign Application Priority Data
Mar. 31, 2006 (ES) PCT/ES06/70040

(51) Int. Cl. B64C 1/06

(52) U.S. Cl. 244/119

(57) ABSTRACT

A process for manufacturing stiffened structures (11) in composite materials formed by an outer skin (13) and a plurality of stiffeners or stringers (15) the cross-section of which has a closed form delimiting an inner opening (23), comprising the following steps: a) Providing a shaping tool (31); b) Providing auxiliary male tools (37) of a material capable of varying its volume due to the effect of temperature and/or pressure, covered with membranes suitable for curing c) Providing stiffeners or stringers (15); d) Arranging the stiffeners or stringers (15) in the tool (31) and the auxiliary male tools (37) in their inner openings (23); e) Laminating the outer skin (13); f) Curing the stiffened structure (11) with high temperature and pressure; g) Removing the auxiliary male tools (37) after reducing their volume; h) Separating the cured stiffened structure (11) from the tool (31). The invention also relates to the auxiliary male tools.

### FIELD OF THE INVENTION

The present invention relates to a process for manufacturing structures formed by a skin with closed section stiffeners or stringers, manufactured with composite material, particularly applicable to aeronautic fuselages.

### BACKGROUND OF THE INVENTION

Weight is an essential aspect in the aeronautical industry, therefore optimized structures manufactured with composite materials prevail over metallic ones.

Automatic carbon fibre taping machines are a great development with respect to manual operation. These machines have a head which presses the surface to be taped, so said surface must react said force.

Applying the foregoing aspects to aeronautical fuselages leads to integrating the panels with their stiffeners or stringers in the lowest number of operations and to optimizing said stiffeners or stringers.

Closed section stiffeners or stringers allow achieving stiffer structures by adding a lower weight per stiffener or stringer. Incorporating this type of stiffener or stringer complicates the manufacturing process because it requires tools inside the stiffeners or stringers allowing the taping of the piece and the curing operation of the composite material and removing the stiffeners or stringers from inside the stiffener or stringer if this is intended to be hollow.

Processes for manufacturing said structures are known in which a stiff element is introduced inside the stiffener or stringer section to react the taping pressure and the composite material curing pressure.

These processes are expensive so it is desirable to have more efficient processes, an objective which is achieved by the present invention.

### SUMMARY OF THE INVENTION

In a first aspect, the present invention proposes a process for manufacturing stiffened structures in composite materials formed by an outer skin and a plurality of stiffeners or stringers whose cross-section has a broken contour with at least one flange joined to the skin, said contour delimiting an inner opening, characterized in that it comprises the following steps:

Providing a shaping tool with an outer surface with a shape similar to that of the structure on the side of the stiffeners or stringers, including slots to house the stiffeners or stringers.

Providing auxiliary male tools consisting of elements made of a material capable of varying its volume due to the effect of temperature and/or pressure, shaped with a geometry similar to the inner opening of the stiffeners or stringers and covered with membranes suitable for curing composite materials.

Providing stiffeners or stringers in fresh or cured state;

Arranging the stiffeners or stringers in the slots of the tool, adapting them to the geometry of the slots and arranging in their inner openings the auxiliary male tools, adapted to their geometry. In this step, the auxiliary male tools help the curing membrane to adapt itself to the inner geometry of each stiffener or stringer.

Laminating the outer skin on the surface formed by the tool, the stiffeners or stringers and the auxiliary male tools. The shaping tool and the auxiliary male tools react to the laminating force.

Curing the stiffened structure at high temperature and pressure conditions.

Removing the auxiliary male tools. After curing, their volume decrease allowing removal.

Separating the cured stiffened structure from the tool.

In a second aspect, the present invention provides auxiliary male tools used in the foregoing processes implemented in a polymer such as polyurethane or polystyrene, which, due to the effect of temperature and/or pressure of the process, undergoes a change that allows removing it later from inside the stiffeners or stringers.

An advantage of the present invention is that it facilitates manufacturing structures in which the section and the area of the stiffeners or stringers vary longitudinally and even have smaller dimensions than the intermediate section in one or both ends, because the auxiliary male tools can be shaped so as to be adapted to it.

Another advantage is that it facilitates using machines with a pressing taping head because the auxiliary male tools provide a substrate inside the stiffeners or stringers for reacting the force of the head.

Other features and advantages of the present invention will be disclosed in the following detailed description of an illustrating embodiment of the object relating to the attached drawings.

### DESCRIPTION OF THE DRAWINGS

FIGS. 1a, 1b and 1c show schematic views of structures formed by a skin and a plurality of omega, trapezium and irregular Z shaped stiffeners or stringers, respectively.

FIG. 2 schematically shows the steps of the process according to the invention for manufacturing a structure formed by a skin and a plurality of omega-shaped stiffeners or stringers by means of which the stiffeners or stringers and auxiliary male tools covered by a membrane suitable for curing are arranged in the structure shaping tool.

FIG. 3 schematically shows the step of the process according to the invention for manufacturing a structure formed by a skin and a plurality of omega-shaped stiffeners or stringers by means of which the taping process of the skin is carried out.

FIG. 4 schematically shows the step of the process according to the invention for manufacturing a structure formed by a skin and a plurality of omega-shaped stiffeners or stringers by means of which the curing process is carried out.

FIG. 5 schematically shows the steps of the process according to the invention for manufacturing a structure formed by a skin and a plurality of omega-shaped stiffeners or stringers by means of which the volume of the auxiliary male tools is reduced and the structure is separated from the tools used for its manufacturing.

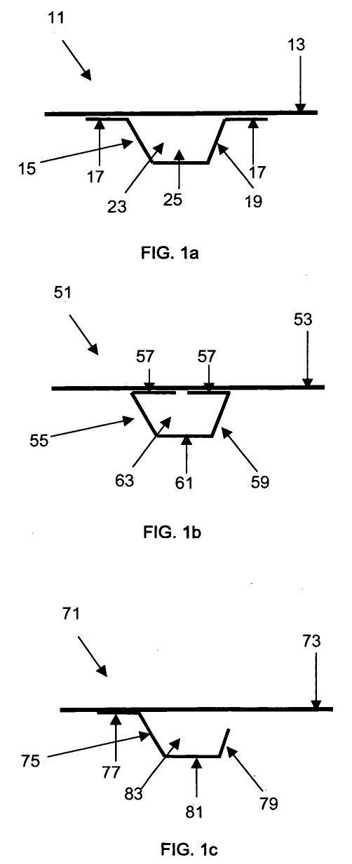

### DETAILED DESCRIPTION OF THE INVENTION

An embodiment of the process according to the invention for manufacturing stiffened structures 11 in composite materials formed by a skin 13 and a plurality of omega-shaped (Ω) stiffeners or stringers 15 with flanges 17 joined to skin 13, and webs 19 separated from it will be described later on.

The process object of the present invention is also applicable for manufacturing a stiffened structure 51 formed by a skin 53 and a plurality of trapezium-shaped stiffeners or stringers 55 with flanges 57 joined to skin 53, and webs 59 and head 61 separated from it, as well as a stiffened structure 71 formed by a skin 73 and a plurality of irregular Z-shaped stiffeners or stringers 75 with a flange 77 joined to the skin 73, and webs 79 and head 81 separated from it.

What stiffeners or stringers 15, 55 and 75 have in common is that their cross-section has a broken contour with at least a flange 17, 57, 77 joined to the skin 13, 53, 73 said contour delimiting an inner opening 23, 63, 83.

Structures 11, 51, 71 can have an open form or a revolving piece form as in the case of airplane fuselage pieces.

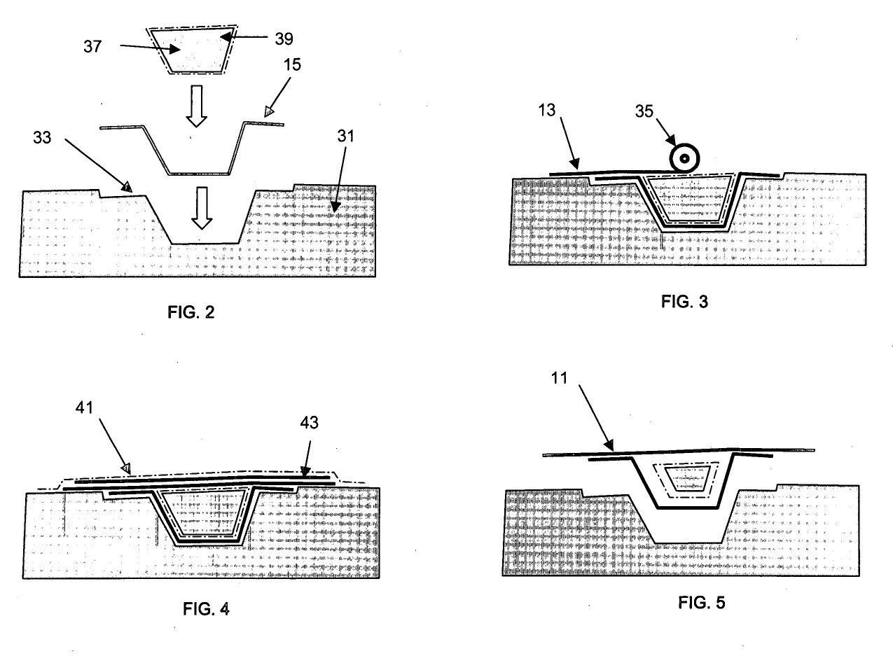

Proceeding now to the description of the process, it can be observed by following FIG. 2, that the omega-shaped stiffeners or stringers 15 are placed on the shaping tool 31 having slots 33, and auxiliary male tools 37 covered with a membrane 39 suitable for curing composite materials are placed on the stiffeners or stringers.

Cured or uncured stiffeners or stringers 15 can be used.

Male auxiliary tools 37 are obtained from a material that by the effect of temperature and/or pressure undergoes a change in volume which allows removing them from the stiffeners or stringers 15 such as for example, a polymer like polyurethane or polystyrene and they are provided with a geometry similar to the inner opening 23 of the stiffener or stringer using a suitable shaping technique.

When each auxiliary male tool 37 is introduced in the opening 23 of the stiffener or stringer 15, the curing membrane 39 is aided in being coupled to the inner geometry of each stiffener or stringer 15.

The stiffeners or stringers 15 and the male tools 37 can be arranged on the shaping tool 31, previously coupling them.

It can be observed in FIG. 3 that in a subsequent step, skin 13 is laminated by means of the head 35 of a taping machine on the surface formed by the shaping tool 31, the stiffeners or stringers 15 and the membrane 39 covering the auxiliary male tools 37. In this step, the shaping tool 31 and the auxiliary male tools 37 react the force of the taping head 35.

A variant of the process is the manual taping operation of skin 13.

It can be observed in FIG. 4 that in a subsequent step, a curing membrane 41, and optionally a caul-plate 43, is placed on the overall structure. Then, the structure is cured at high temperature and pressure conditions in an autoclave. During the curing process, membrane 39 covering the auxiliary male tools 37 communicates the inside of the stiffeners or stringers 15 with the inner autoclave atmosphere and achieves maintaining the pressure on the surrounding composite material, i.e. the composite material of the stiffener or stringer 15 and of the skin 13, producing the curing.

Once the structure 11 is cured and cooled down, the auxiliary male tools 37 are removed, as illustrated in FIG. 5 by depicting them with a size smaller than the initial size, for facilitating the separation of structure 11 from the shaping tool 31 and the removal of the auxiliary male tools 37 from inside the stiffeners or stringers 15.

Modifications comprised within the scope defined by the following claims can be introduced in the preferred embodiment which has just been described.

1. A process for manufacturing stiffened structures (11) in composite materials formed by an outer skin (13) and a plurality of stiffeners or stringers (15) whose cross-section has a broken contour with at least one flange (17) joined to the skin (13), said contour delimiting an inner opening (23), characterized in that it comprises the following steps:
a) Providing a tool (31) with an outer surface with a shape similar to that of structure (11) on the side of the stiffeners or stringers (15), including slots (33) to house the stiffeners or stringers (15);
b) Providing auxiliary male tools (37) consisting of elements made of a material capable of varying its volume due to the effect of temperature and/or pressure, shaped with a geometry similar to the inner opening (23) of the stiffeners or stringers and covered with membranes suitable for curing composite materials;
c) Providing stiffeners or stringers (15) in fresh or cured condition;
d) Arranging the stiffeners or stringers (15) in the slots (33) of tool (31), adapting them to the geometry of the slots and arranging in their inner openings (23) the auxiliary male tools (37), adapted to their geometry;
e) Laminating the outer skin (13) on the surface formed by the tool (31), the stiffeners or stringers (15) and the auxiliary male tools (37);
f) Curing the stiffened structure (11) at high temperature and pressure conditions;
g) Removing the auxiliary male tools (37);
h) Separating the cured stiffened structure (11) from the tool (31).

2. A process for manufacturing stiffened structures (11) in composite materials according to claim 1, characterized in that the stiffened structure (11) is a tubular piece.

3. A process for manufacturing stiffened structures (11) in composite materials according to claim 1, characterized in that the stiffeners or stringers (15) have an omega shape.
A process for manufacturing stiffened structures (11) in composite materials according to claim 1, characterized in that in step d) the stiffeners or stringers are arranged in the slots (33) of the tool (31) having previously coupled the auxiliary male tools (37) in their inner openings (23).

5. A process for manufacturing stiffened structures (11) in composite materials according to claim 1, characterized in that step e) is carried out by a head (35) of a taping machine.

6. A process for manufacturing stiffened structures (11) in composite materials according to claim 1, characterized in that before step f) a caul-plate (43) is placed on the skin (13).

7. An auxiliary male tool (37) used in a process for manufacturing stiffened structures (11) according to claim 1, characterized in that it is made of polyurethane.

8. An auxiliary male tool (37) used in a process for manufacturing stiffened structures (11) according to claim 1, characterized in that it is made of polystyrene.
